(19) United States
(12) Patent Application Publication
(10) Pub. No.: US 2026/0249483 A1
(43) Pub. Date: Aug. 27, 2026

(54) WEARABLE SYSTEMS, METHODS, AND DEVICES FOR HUMANOID ROBOTICS

(71) Applicant: Proception.ai Inc., Palo Alto, CA (US)

(72) Inventors: Zhongjie Li, Sunnyvale, CA (US); Jianxiang Xu, Palo Alto, CA (US)

(21) Appl. No.: 19/061,685

(22) Filed: Feb. 24, 2025

(51) Int. Cl. B25J 13/06; B25J 13/08; G06F 3/01

(52) U.S. Cl. CPC B25J 13/06; B25J 13/084; G06F 3/014

(57) ABSTRACT

Wearable systems, methods, and devices for controlling a robotic component are provided. The wearable system has a first wearable article worn by a user and a second wearable article worn by the robotic component. The first wearable article has a first set of position sensors, a first set of tactile sensors, and a second set of tactile sensors. The first set of position sensors tracks a position of the first wearable article. At least one tactile sensor of the first set of tactile sensors determines a first force applied to a first physical object and is positioned at an intermediate phalanx region of a respective finger portion of the first wearable article. At least one tactile sensor of the second set of tactile sensors determines a second force applied to the first physical object and is positioned at a distal phalanx region of the respective finger portion.

### TECHNICAL FIELD

This relates generally to wearable systems, and more specifically to wearable systems, methods, and devices for large-scale training and control of humanoid robotic components.

### BACKGROUND

Robotics is gaining popularity with rapid advancements in robotic design, manufacturing, artificial-intelligence, and general artificial-intelligence. Increased efforts are being directed towards the adoption of robotics across several industrial and consumer-related fields. However, the rapid deployment of robotic components and/or humanoid robots with the required accuracies and capabilities at low cost and at large scale remains challenging.

Accordingly, there is a need for accurate, large-scale, and efficient training and manipulation of robotic components, grounding the human-robot interaction in real-world human interactions and perceptions. One aspect of the present disclosure overcomes the shortcomings of previous technologies that are reliant on vision systems and/or robotic control systems prone to drift and other accuracy errors by providing wearable systems, methods, and devices for human-derived, large-scale robotic training and control. Another aspect of the present disclosure provides for the training, control, and/or manipulation of a large number of robotic components by a single user in synchronized real-time using highly accurate, cost effective, seamless, and efficient wearable systems. The wearable systems could be in various shapes of user-worn apparatus such as gloves, arm-wear, exoskeleton-like interfaces, wristbands, etc.

In accordance with some embodiments, wearable systems, methods, and devices for controlling a robotic component are described. The wearable systems provide for real-time, large-scale, accurate, and cost-effective data acquisition while worn by a user that is analyzed for the real-time training, control, and/or manipulation of the counterpart robotic component. In some embodiments, the counterpart robotic component corresponds to the shape and/or size of the wearable system as worn by the user. In some embodiments, the wearable system includes two wearable articles, such as a first wearable article worn by a user and at least a second wearable article worn by the counterpart robotic component for real-time, synchronized training and control of the counterpart robotic component. In some embodiments, the wearable article worn by the user is used to train, control, and/or manipulate a plurality of robotic components in real-time and/or in-sync, opening-up avenues for large-scale, accurate, efficient, and low-cost training of robotics. In some embodiments, the robotic components are humanoid robotic components that mimic a look, structure, size, etc. of different parts of the human body and the wearable articles are configured to be worn by users (e.g., over the respective body area) and the respectively corresponding humanoid robotic components.

In accordance with some embodiments, the wearable system has a first wearable article worn by a user and a second wearable article worn by the robotic component. The first wearable article has at least a first set of position sensors, a first set of tactile sensors, and a second set of tactile sensors. The first set of position sensors tracks a position of the first wearable article. At least one tactile sensor of the first set of tactile sensors determines a first force applied to a first physical object and is positioned at an intermediate phalanx region of a respective finger portion of the first wearable article. At least one tactile sensor of the second set of tactile sensors determines a second force applied to the first physical object and is positioned at a distal phalanx region of the respective finger portion of the first wearable article.

In some embodiments, the second wearable article has a second set of position sensors for tracking a position of the second wearable article, a third set of tactile sensors, and a fourth set of tactile sensors. In some instances, at least one tactile sensor of the third set of tactile sensors determines a third force applied to a second physical object and is positioned at an intermediate phalanx region of a respective finger portion of the second wearable article. In some instances, at least one tactile sensor of the fourth set of tactile sensors determines a fourth force applied to the second physical object and is positioned at a distal phalanx region of a respective finger portion of the second wearable article.

In some embodiments, the first set of position sensors, the first set of tactile sensors, and the second set of tactile sensors generate training data while the first wearable article is worn by the user and the second wearable article trains a movement of the humanoid robotic component based on the training data.

In some embodiments, the second wearable article has a plurality of positioning datums for positioning the second wearable article on the humanoid robotic component.

In some embodiments, the first wearable article has an additional set of tactile sensors for determining a third force applied to the first physical object. In some instances, each tactile sensor of the additional set of tactile sensors is positioned at a palm region of the first wearable article.

In some embodiments, a first position sensor of the first set of position sensors is positioned at a palm region of the first wearable article.

In some embodiments, a second position sensor of the first set of position sensors is positioned at a proximal phalanx region of a finger portion of the first wearable article.

In some embodiments, a third position sensor and the second position sensor of the first set of position sensors are positioned at different phalanx regions of a same finger portion of the first wearable article.

In some embodiments, the second wearable article and the first wearable article are communicatively coupled to one another.

In accordance with some embodiments, a method for controlling and/or training (manipulating) a humanoid robotic system is described. The method receives, from a first wearable article worn by a user, training data for controlling the humanoid robotic component. The training data can be based on (i) receiving, from a first set of position sensors of the first wearable article, position information of the first wearable article; (ii) receiving, from at least one tactile sensor of a first set of tactile sensors of the first wearable article, first intermediate phalanx force information associated with a first physical object,; and (iii) receiving, from at least one tactile sensor of a second set of tactile sensors, first distal phalanx force information associated with the first physical object. In some instances, the at least one tactile sensor of the first set of tactile sensors is positioned at an intermediate phalanx region of a respective finger portion of the first wearable article. In some instances, the at least one tactile sensor of the second set of tactile sensors is positioned at a distal phalanx region of a respective finger portion of the first wearable article. The method determines position information for the humanoid robotic component based on the position information of the first wearable article; determines movement information for the humanoid robotic component based on the on the first intermediate phalanx force information and the first distal phalanx force information; and transmits the position information and the movement information to a second wearable article worn by the humanoid robotic component.

In some embodiments, the method modifies a position of the humanoid robotic component based on the transmitted position information for the humanoid robotic component. In some embodiments, the method modifies a position of the humanoid robotic component based on the second wearable article and/or the transmitted position information for the humanoid robotic component.

In some embodiments, the method modifies a movement of the humanoid robotic component based on the transmitted movement information for the humanoid robotic component. In some embodiments, the method modifies a movement of the humanoid robotic component based on the second wearable article and/or the transmitted movement information.

In some embodiments, the second wearable article has a second set of position sensors, a third set of tactile sensors, and a fourth set of tactile sensors. In some instances, the second set of position sensors tracks a position of the second wearable article. In some instances, at least one tactile sensor of the third set of tactile sensors determines a third force applied to a second physical object and is positioned at an intermediate phalanx region of a respective finger portion of the second wearable article. In some instances, at least one tactile sensor of the fourth set of tactile sensors determines a fourth force applied to the second physical object and is positioned at a distal phalanx region of a respective finger portion of the second wearable article.

In some embodiments, a first position sensor of the first set of position sensors is positioned at a palm region of the first wearable article and a second position sensor of the first set of position sensors is positioned at a proximal phalanx region of a finger portion of the first wearable article.

In some embodiments, a third position sensor and the second position sensor of the first set of position sensors are positioned at different phalanx regions of the same finger portion of the first wearable article.

In some embodiments, the method determines, based on an additional set of tactile sensors positioned at a palm region of the first wearable article, palm force information associated with the first physical object, and modifies, based on the palm force information associated with the first physical object, a force applied to a second physical object by the humanoid robotic component.

In some embodiments, the method determines a second intermediate phalanx force for a second physical object based on the intermediate phalanx force information received from the at least one tactile sensor of the first set of tactile sensors of the first wearable article, determines a second distal phalanx force for the second physical object based on the distal phalanx force information received from the at least one tactile sensor of the second set of tactile sensors, and modifies, based on the second intermediate phalanx force and the second distal phalanx force, a force applied to the second physical object by the humanoid robotic component.

In accordance with some embodiments, non-transitory computer-readable storage medium storing instructions, which, when executed by a system that has an apparatus and one or more processors, causes the one or more processors to receive, from a first wearable article worn by a user, training data for controlling a humanoid robotic component. The training data is based on (i) receiving, from a first set of position sensors of the first wearable article, position information of the first wearable article; (ii) receiving, from at least one tactile sensor of a first set of tactile sensors of the first wearable article, first intermediate phalanx force information associated with a first physical object; and (iii) receiving, from at least one tactile sensor of a second set of tactile sensors, first distal phalanx force information associated with the first physical object. In some instances, the at least one tactile sensor of the first set of tactile sensors is positioned at an intermediate phalanx region of a respective finger portion of the first wearable article. In some instances, the at least one tactile sensor of the second set of tactile sensors is positioned at a distal phalanx region of the respective finger portion of the first wearable article. The non-transitory computer-readable storage medium further stores instructions that cause the one or more processors to (i) determine position information for the humanoid robotic component based on the position information of the first wearable article; (ii) determine movement information for the humanoid robotic component based on the on the first intermediate phalanx force information and the first distal phalanx force information; and (iii) transmit the position information and the movement information to a second wearable article worn by the humanoid robotic component.

In some embodiments, non-transitory computer-readable storage medium further stores instructions that cause the one or more processors to modify a position of the humanoid robotic component based on the transmitted position information for the humanoid robotic component.

In some embodiments, non-transitory computer-readable storage medium further stores instructions that cause the one or more processors to modify a movement of the humanoid robotic component based on the transmitted movement information for the humanoid robotic component.

In some embodiments, the second wearable article has a second set of position sensors for tracking a position of the second wearable article, a third set of tactile sensors, and a fourth set of tactile sensors. In some instances, at least one tactile sensor of the third set of tactile sensors determines a third force applied to a second physical object and is positioned at an intermediate phalanx region of a respective finger portion of the second wearable article. In some instances, at least one tactile sensor of the fourth set of tactile sensors determines a fourth force applied to the second physical object and is positioned at a distal phalanx region of a respective finger portion of the second wearable article.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A and 1B show perspective views of example wearable system, in accordance with some embodiments.

FIG. 1C shows a perspective view of an example wearable system with sensor positioning regions, in accordance with some embodiments.

FIG. 2A shows a palmar-side perspective view of an example wearable system with tactile sensors, in accordance with some embodiments.

FIG. 2B shows a dorsal-side perspective view of an example wearable system with position sensors, in accordance with some embodiments.

FIG. 3A shows a palmar-side illustration of an example wearable system, in accordance with some embodiments.

FIG. 3B shows a dorsal-side illustration of an example wearable system, in accordance with some embodiments.

FIG. 4A shows an example illustration of positioning datums for an example wearable system, in accordance with some embodiments.

FIG. 4B shows an example illustration of a humanoid robotic hand with positioning datums, in accordance with some embodiments.

FIG. 4C shows an example illustration of a wearable system with positioning datums, in accordance with some embodiments.

FIG. 5A shows an example block diagram of a wearable system for a user, in accordance with some embodiments.

FIG. 5B shows an example block diagram of a wearable system coupled with a humanoid robotic component, in accordance with some embodiments.

FIGS. 6A and 6B show an example method of operation for a wearable system, in accordance with some embodiments.

FIGS. 7A and 7B illustrate a humanoid robot and a user having a plurality of wearable articles in communication with one another, in accordance with some embodiments.

FIG. 7C shows a perspective view of a user having a plurality of wearable articles of a wearable system in communication with smart glasses, in accordance with some embodiments.

The figures depict embodiments of the present disclosure for purposes of illustration only. One skilled in the art will readily recognize from the following description that alternative embodiments of the structures and methods illustrated herein may be employed without departing from the principles, or benefits mentioned, of the disclosure described herein.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first set of sensors could be termed a second set of sensors, and, similarly, a second set of sensors could be termed a first set of sensors, without departing from the scope of the various described embodiments. The first set of sensors and the second set of sensors are both groups of sensors, but they are not the same sensors.

The terminology used in the description of the various described embodiments herein is for the purpose of describing particular embodiments only and is not intended to be limiting. As used in the description of the various described embodiments and the appended claims, the singular forms "a," "an," and "the" are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features, integers, steps, operations, elements, and/or components, but do not preclude the presence or addition of one or more other features, integers, steps, operations, elements, components, and/or groups thereof. The term "exemplary" is used herein in the sense of "serving as an example, instance, or illustration" and not in the sense of "representing the best of its kind."

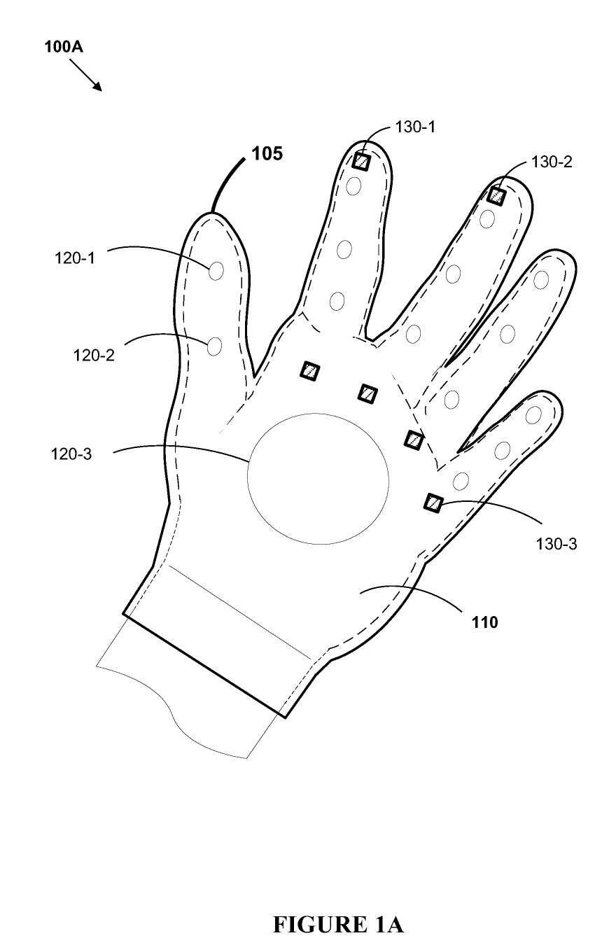

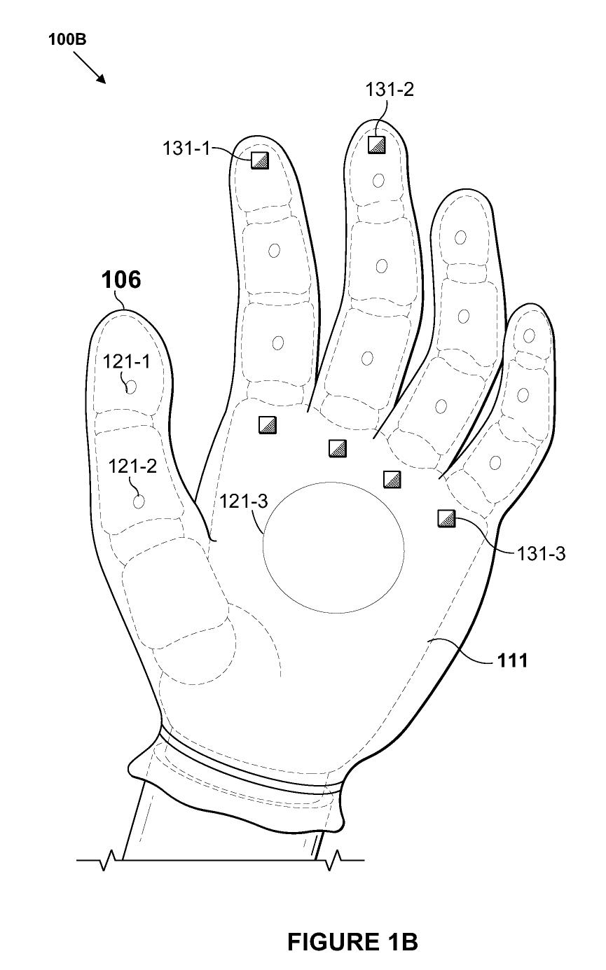

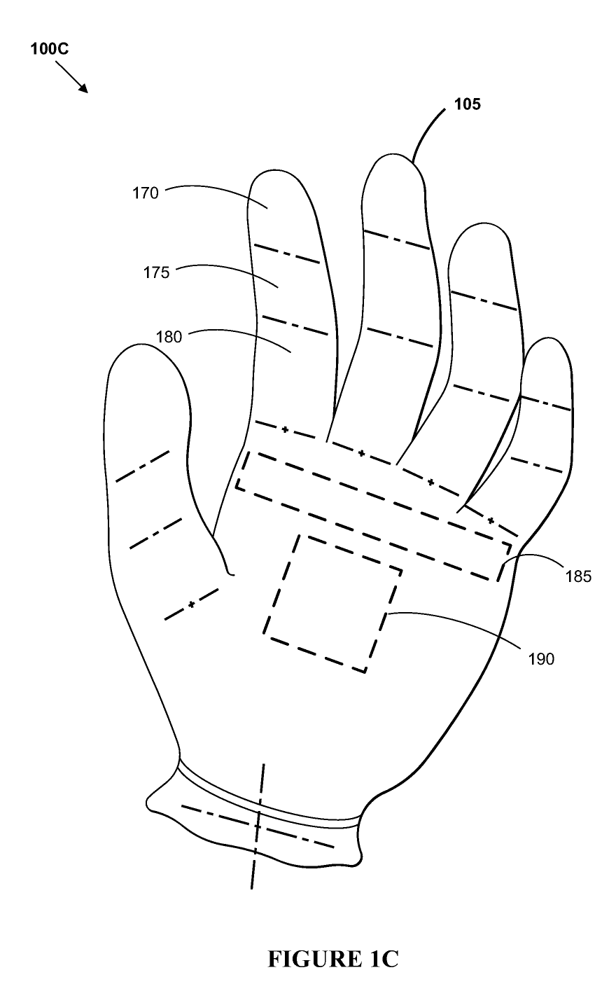

FIGS. 1A and 1B show perspective views of example wearable systems, in accordance with some embodiments. FIG. 1A shows an example perspective view of a wearable system 100A shaped in a form of a wearable glove 105 with a plurality of electronic, sensory, network, user interface, display, power, and/or computational components, as worn by a user. In some embodiments, the wearable system 100A is configured to fit and/or be worn over a user hand 110. Alternatively, or additionally, the wearable system 100A can be configured to be worn over one or more body regions, such as a finger, hand, arm, shoulder, foot, leg, etc. For example, the wearable system 100A is fabricated with a plurality of sizes to fit varying user sizes as varying sizes of gloves, boots, shoulder straps, arm straps, etc. In some embodiments, the wearable system 100A has a plurality of wearable articles, communicatively coupled with each other, and each wearable article is fabricated out of an elastomer, a fabric, and/or other material-composites with one or more layers associated with a wiring layer(s), an electronics circuitry layer(s), a sensor layer(s), support layer(s), aesthetic component layer(s), etc.

In some embodiments, the wearable system 100A is configured for large-scale data acquisition through a plurality of data sources and/or channels when worn by a user. For example, the wearable system 100A receives real-time data corresponding to user movement and/or manipulation of an object. The real-time data can be received from a plurality of sensors positioned within predefined regions of the wearable system. For example, the plurality of sensors includes a plurality of tactile sensors (e.g., 120-1, 120-2, 120-3, etc.) and a plurality of positioning sensors (e.g., 130-1, 130-2, 130-3, etc.).

In some embodiments, the plurality of tactile sensors (e.g., 120-1, 120-2, 120-3, etc.) is positioned on the palmar-side of the wearable system 100A. The plurality of tactile sensors (e.g., 120-1, 120-2, 120-3, etc.) detect and acquire data associated with a surface physical contact by another surface, (e.g., 120-1, 120-2, 120-3, etc.) object, or person on the palmar-side of the wearable glove 105. In some embodiments, one or more of the plurality of tactile sensors (e.g., 120-1, 120-2, 120-3, etc.) is positioned on the dorsal-side of the wearable system 100A to detect and acquire data associated with a surface physical contact by another surface, object, or person on the dorsal-side and/or the palmar-side of the wearable system 100A. For example, for certain applications that require hand manipulations in constrained spaces, training and/or manipulation of robotic components can require tactile data from the palmar-side and dorsal-side regions of the wearable system 100A.

In some embodiments, the plurality of positioning sensors (e.g., 130-1, 130-2, 130-3, etc.) is positioned on the dorsal-side of the wearable system 100A while the plurality of tactile sensors (e.g., 120-1, 120-2, 120-3, etc.) is positioned on the palmar-side of the wearable system 100A.

In some embodiments, the plurality of positioning sensors (e.g., 130-1, 130-2, 130-3, etc.) are inertial measurement units (IMUs). In some embodiments, the positioning sensors are IMUs and other locating sensors such as gyroscopes, accelerometers, magnetometers, etc. for detecting motion, calibrating the positioning sensors, internal to the IMUs, or located externally to the IMUs. In some embodiments, the IMUs can have varying degrees of freedom (DoF) depending on the type and number of locating sensors communicatively coupled to the IMUs, and either located internally or externally to the IMUs.

FIG. 1B shows an example perspective view of a wearable system 100B shaped in a form of a wearable glove 106 with a plurality of electronic, sensory, network, user interface, display, power, and/or computational components, as worn by a humanoid robotic hand 111. In some embodiments, the wearable system 100B with the wearable glove 106 is the same as the wearable system 100A with the wearable glove 105. For example, the wearable glove 106 includes a plurality of sensors such as a plurality of tactile sensors (e.g., 121-1, 121-2, 121-3, etc.) and a plurality of positioning sensors (e.g., 131-1, 131-2, 131-3, etc.).

In some embodiments, the plurality of tactile sensors (e.g., 121-1, 121-2, 121-3, etc.) is positioned on the palmar-side of the wearable system 100B. In some embodiments, one or more of the plurality of tactile sensors (e.g., 121-1, 121-2, 121-3, etc.) is positioned on the dorsal-side of the wearable system 100B to detect and acquire data associated with a surface physical contact by another surface, object, or person on the dorsal-side and/or the palmar-side of the wearable system 100B. For example, for certain applications that require hand manipulations in constrained spaces, as described above with respect to FIG. 1A, training and/or manipulation of robotic components can require tactile data from the palmar-side and dorsal-side regions of both the wearable systems 100A and 100B.

In some embodiments, the plurality of positioning sensors (e.g., 131-1, 131-2, 131-3, etc.) is positioned on the dorsal-side of the wearable system 100B while the plurality of tactile sensors (e.g., 121-1, 121-2, 121-3, etc.) is positioned on the palmar-side of the wearable system 100B.

In some embodiments, the wearable gloves 105 and 106 are the same and can be worn interchangeably by the user and by the humanoid robotic component. For example, the wearable system 100B with the wearable glove 106 is fabricated with a plurality of sizes, such as those described with respect to FIG. 1B described above, to fit varying robotic components and their counterpart user body areas. As another example, the wearable gloves 105 and 106 are identical in size, shape, component structure, and function, and can be worn at the same time by the user (e.g., over the hand 110) and the counterpart humanoid robotic component 111 for real-time, synchronized data acquisition, training, and/or control.

FIG. 1C shows a perspective view of an example wearable system 100C with sensor positioning regions, in accordance with some embodiments. In some embodiments, each of the sensors (e.g., the plurality of tactile sensors 120-1, 120-2, 121-1, 121-2…, the plurality of positioning sensors 130-1, 130-2, 131-1…, of FIGS. 1A and 1B described above) are positioned at pre-defined locations on either the palmar-side or the dorsal-side of the wearable glove 105 worn by the user and the wearable glove 106 worn by the humanoid robotic component. The pre-defined regions can be divided into a distal phalanx region 170, an intermediate phalanx region 175, a proximate phalanx region 180 for each respective finger portion of the wearable articles (e.g., the wearable glove 105, the wearable glove 106, etc.). In some embodiments, the pre-defined regions include a central palm-region 190 and an intermediate palm-region 185.

In some embodiments, the plurality of position sensors is a first set of position sensors of a first wearable article (e.g., 130-1, 130-2, etc. of FIG. 1A) and a second set of position sensors (e.g., 131-1, 131-2 etc. of FIG. 1B) of a second wearable article. In some embodiments, each set of position sensors can correspond to respective positioning region (e.g., 170, 175, 180, 185, 190, etc.) of the wearable articles (e.g., 100A, 100B, 100C). For example, each set of position sensors can correspond to distal phalanx regions (e.g., 170), intermediate phalanx regions (e.g., 175), proximate phalanx regions (e.g., 180) of one or more finger regions, the palm regions (e.g., 190), or other intermediate palm-regions (e.g., 185) of the wearable articles.

In some embodiments, the plurality of tactile sensors is a first set of tactile sensors of the first wearable article, a second set of tactile sensors of the first wearable article, a third set of tactile sensors of the second wearable article, and at least a fourth set of tactile sensors of the second wearable article. Each set of tactile sensors can correspond to a respective finger and/or respective positioning region (e.g., 170, 175, 180, 185, 190, etc.) of the wearable articles (e.g., 100A, 100B, 100C). For example, each set of tactile sensors can correspond to distal phalanx regions (e.g., 170), intermediate phalanx regions (e.g., 175), and/or proximate phalanx regions (e.g., 180) of a finger region of the wearable articles.

In some embodiments, positioning of the sensors is based on a number of the sensors, a desired accuracy, cost, data-bandwidth, and/or data processing speeds of the wearable systems (e.g., wearable system 100A, 100B, etc). In some embodiments, the pre-defined positioning of the sensors is based on form-factor constrains of each of the sensors, the wearable articles sizes, and a number of sensors on the palmar-side and the dorsal-side of the wearable articles. For example, the pre-defined positions for the tactile sensors and the positioning sensors are based on positioning up to 100 tactile sensors per finger, up to 5 positioning sensors per finger, and up to 1000 sensors per wearable article (e.g., wearable article 105, wearable article 106, etc.). As another example, the pre-defined positions for the tactile sensors are based on at least tactile sensor (e.g., 120-3, 121-3) covering a majority of the palm-region of the palmar-side of the wearable articles. As another example, the pre-defined positions for the positioning sensors are based on at least positioning sensor (e.g., 130-3, 131-3) located on the palmar-side of the wearable articles because the palm-region is fairly rigid and additional positing sensors can be redundant. As another example, the pre-defined positions for the position sensors are based on positioning two to four position sensors on each finger portion of the wearable articles. In some embodiments, the pre-defined positions for the sensors is further based on the number of DoFs associated with each of the position sensors of the plurality of position sensors.

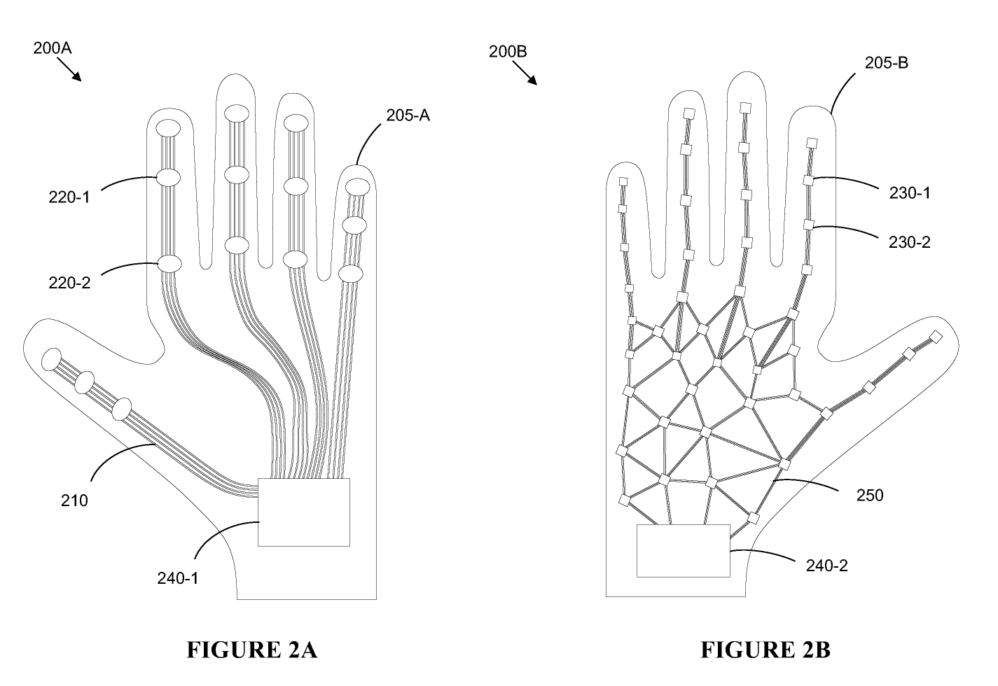

In some embodiments, the pre-defined positioning of the sensors is further based on form-factor constraints when including additional processing circuitry, memory, user interfaces, control panels, communication pathways (e.g., wiring), and/or other supporting structures. For example, for achieving desired flexibility, reliability, form-factor, cost, accuracy, and usability metrics the tactile and/or position sensors are packaged into thin layers as described in further detail with respect to FIGS. 2A and 2B below.

FIG. 2A shows a palmar-side perspective view of an example wearable system 200A with tactile sensors, in accordance with some embodiments. In some embodiments, the plurality of tactile sensors (e.g., 220-1, 220-2, 240-1, etc.) for the wearable system 200A (similar to the wearable systems 100A and 100B described with respect to FIGS. 1A and 1B above) are packaged into thin layers with printable electronics on soft elastomer or other material composites and laminated on fabric. Additionally, or alternatively, the plurality of tactile sensors for the wearable system 200A are packaged into thin layers with wiring 210 sewn onto the fabric material directly.

FIG. 2B shows a dorsal-side perspective view of an example wearable system 200B with position sensors, in accordance with some embodiments. In some embodiments, the plurality of position sensors (e.g., 230-1, 230-2, 240-2, etc.) for the wearable system 200B (similar to the wearable systems 100A and 100B described with respect to FIGS. 1A and 1B above) are packaged into thin layers with printable electronics on soft elastomer or other material composites and laminated on fabric. Additionally, or alternatively, the plurality of position sensors for the wearable system 200B are packaged into thin layers with wiring 250 sewn onto the fabric material directly.

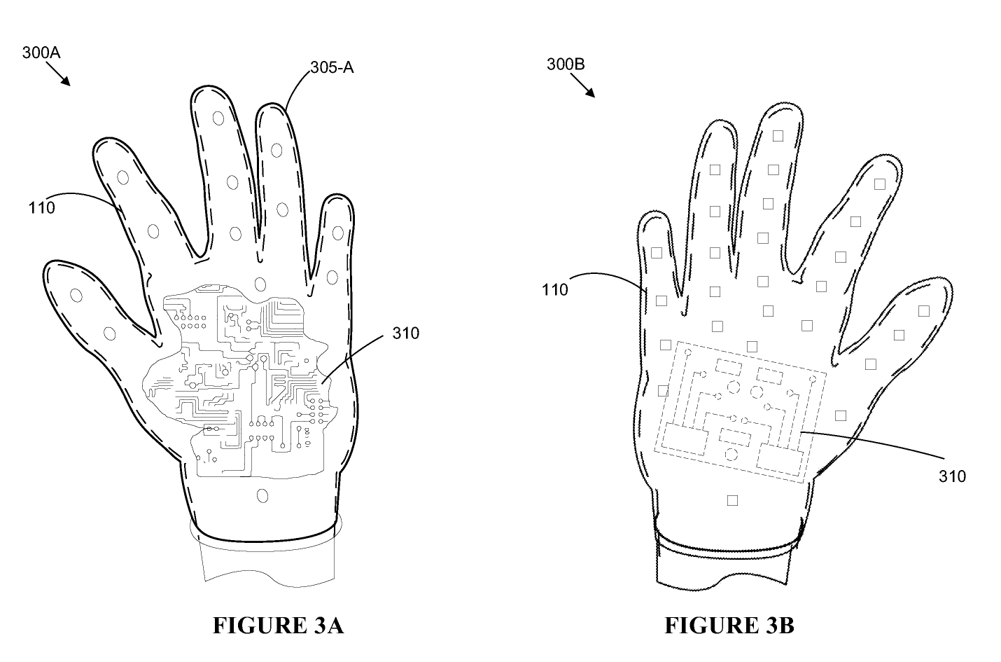

FIG. 3A shows a palmar-side illustration of an example wearable system 300A, in accordance with some embodiments. The wearable system 300A shows a wearable article 305A, (such as 105A of FIG. 1A and 205-A of FIG. 2A described above) with an underlying printed circuit board (PCB) for handling real-time, data-processing for the wearable system 300A when worn by the user hand 110. FIG. 3B shows a dorsal-side illustration of an example wearable system 300B when worn by the user hand 110, in accordance with some embodiments. In some embodiments, the PCB 310 is positioned near, on, or in-proximity to the dorsal-side of the wearable system 300B. In some embodiments, the PCB on the dorsal-side of the wearable system 300B is a distinct and second PCB from the PCB positioned near, on, or in-proximity to the palmar-side of the wearable system 300A.

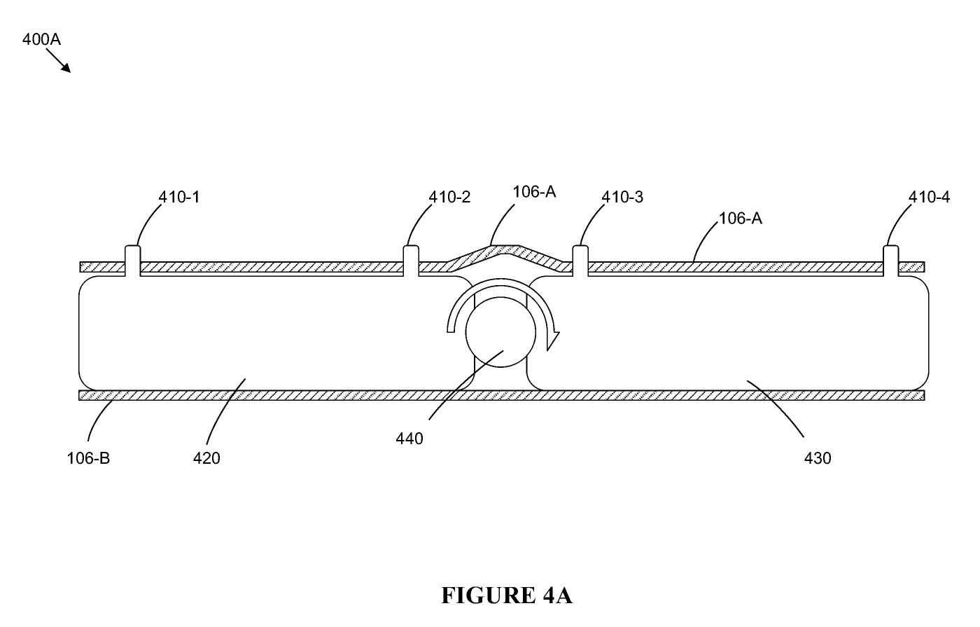

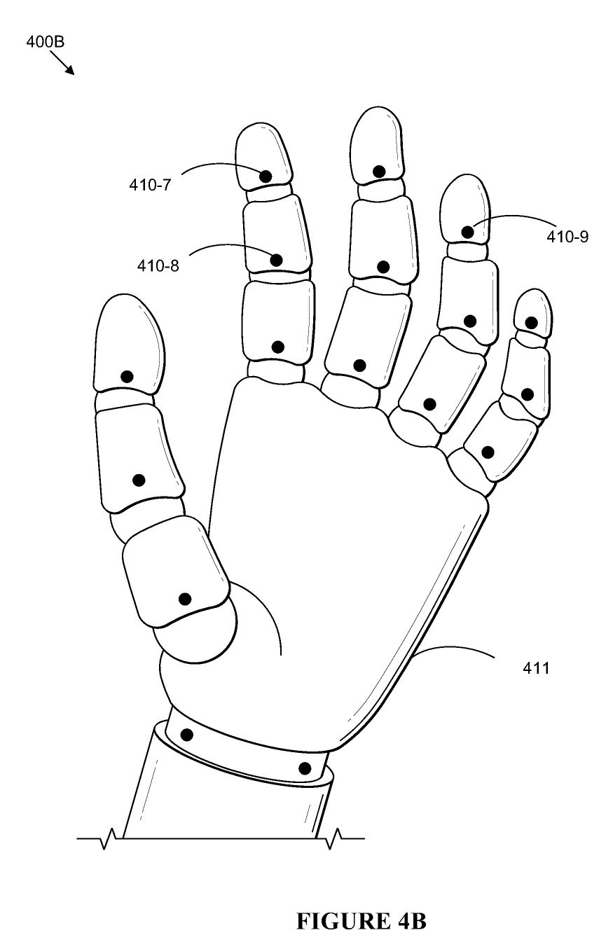

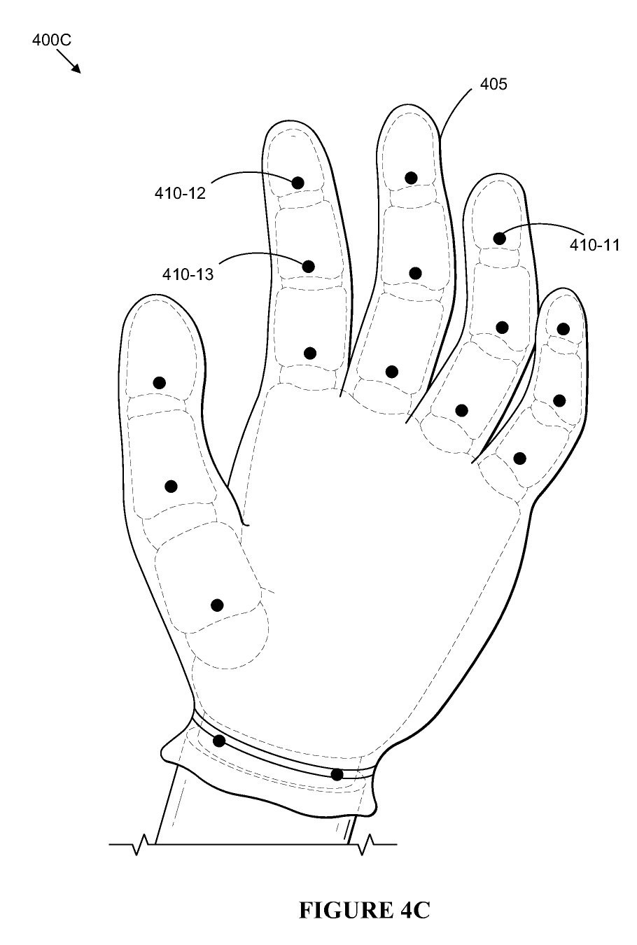

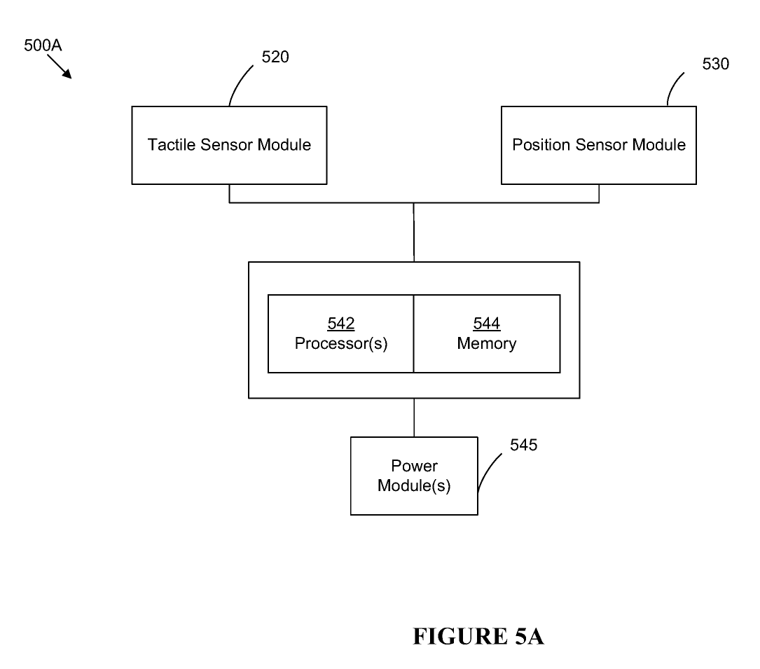

FIG. 4A shows an example illustration of positioning datums for an example wearable system 400A, in accordance with some embodiments. In some embodiments, the wearable system 400A is a portion of the wearable system 100B, worn by the humanoid robotic component described above. For example, the wearable system 400A shows a finger portion of the humanoid robotic component with two phalanx regions 420 and 430, separated by a joint 440, with positioning datums or locators 410-1, 410-2, 410-3, and 410-4. The wearable system 400A has pre-defined holes to accommodate and align the top (e.g., 106-A) and bottom surfaces (e.g., 106-B) of the wearable article 106 with the phalanx portions of the robotic component. The positioning datums or locators increase the accuracy of data training, control, and/or manipulation by reducing or largely eliminating relative motion between the wearable article and the humanoid robotic component.

In some embodiments, the wearable article 400A has a top surface 106-A that corresponds to a palmer-side of the wearable system 100B for the robotic component 111 of FIG. 1A. The top surface 106-A that is located between positioning datums on either side of a robotic joint can be configured with additional leeway to account for joint mobility and/or flexibility.

FIG. 4B shows an example illustration of a humanoid robotic hand with positioning datums, in accordance with some embodiments. As described above with respect to FIG. 4A, the humanoid robotic component can include positioning datums 410-7, 410-8, 410-9, etc. (similar to the positioning datums or the locators 410-1, 410-2, 410-3, and 410-4 described above in FIG. 4A) to minimize or eliminate relative motion between the humanoid robotic component 411 and the wearable article. This increases accuracy and reduces translations errors when training and/or controlling the humanoid robotic component based on data acquisition from the counterpart wearable article worn by the user.

In some embodiments, a larger number of positioning datums are located on larger regions of the humanoid robotic component that are associated with dexterous movements and/or a higher number of DoFs. For example, at least one positioning datum is located on a finger region of the humanoid robotic hand. As another example, no positioning datum is located on a palm region of humanoid robotic hand because the palm region does not require movement control independent of the robotic finger appendages. As another example, a robotic arm with multiple DoFs and/or manipulators that needs to be trained to perform complex tasks has at least three positioning datums located across each of the manipulators.

FIG. 4C shows an example illustration of a wearable system 400C with positioning datums, in accordance with some embodiments. In some embodiments, the wearable system 400C has a wearable glove 405 with a plurality of positioning datums 410-11, 410-12, 410-13, etc. to align-with and fit into the humanoid robotic component. In some embodiments, the humanoid robotic component and the wearable 405, both, have positioning datums or locators to minimize or eliminate relative motion between the wearable glove and the humanoid robotic component.

In some embodiments, a larger number of positioning datums are located on larger regions of the wearable system 400C that are associated with dexterous movements and/or a higher number of DoFs. For example, at least one positioning datum is located on a finger region of the wearable system 400C. As another example, no positioning datum is located on a palm region of the wearable system 400C because the palm region does not experience as much movement of the underlying robotic component. As another example, a wearable system for a robotic arm with multiple DoFs and/or manipulators that needs to be trained to perform complex tasks has at least three positioning datums located across each of the wearable regions worn over their respective manipulators.

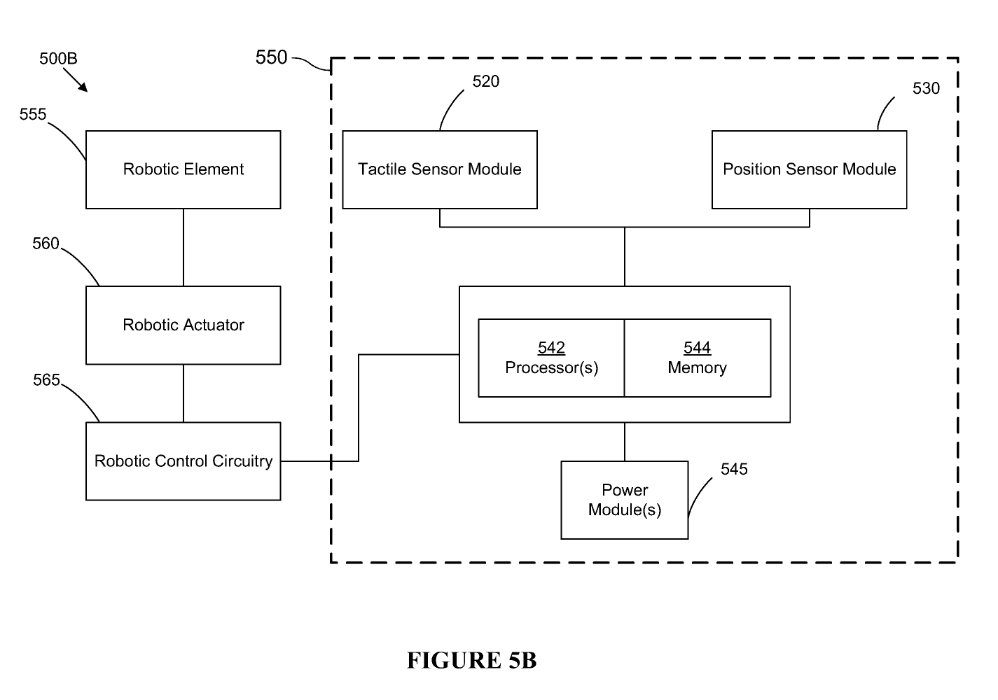

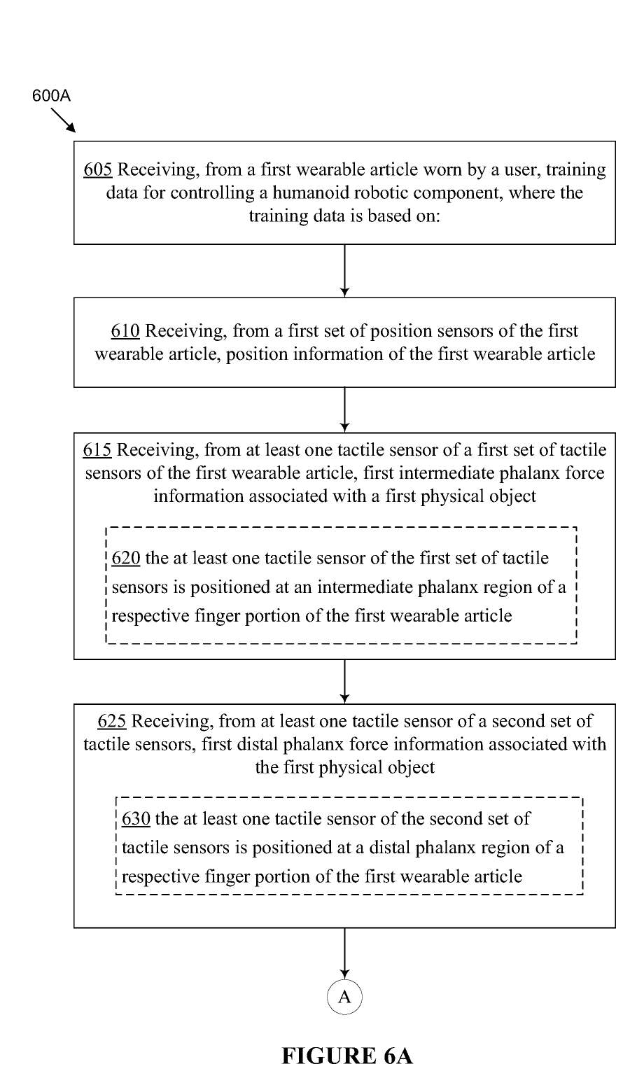

FIG. 5A shows an example block diagram of a wearable system for a user, in accordance with some embodiments. In some embodiments, the wearable system 500A is configured to be worn by a user, as described above with respect to FIGS. 1A-4C, has control and processing circuitry (such as for the first set of tactile sensors, the second set of tactile sensors, the first set of position sensors, etc.) and memory. The control and processing circuitry can include a tactile sensor module 520 and a position sensor module 530 in communication with one or more processor(s) 542, memory 544, and power module(s) 545.

The tactile sensor module 520 interfaces with one or more tactile sensors coupled with the wearable system (such as the first set of tactile sensors of FIG. 1A, FIG. 2A, and FIG. 3A). In some embodiments, the tactile sensor module 520 receives signals when the one or more tactile sensors is activated by surface physical contact by another surface, object, or person. The activation can be via a single point of force, or a pressure array or matrix with multiple points of contact with different pressure values. In some embodiments, the terms tactile sensor and touch sensor are used interchangeably.

The position sensor module 530 interfaces with one or more position sensors (such as the first set of position sensors and the second set of position sensors of FIG. 1A, FIG. 2A, and FIG. 3A), inertial measurement unit(s) (IMUs), one or more position cameras, one or more locators, or a subset or superset thereof (e.g., the one or more processors 542 and memory 544, one or more display devices, one or more user interface devices, etc.) coupled with the wearable system.

In some embodiments, the one or more processor(s) 542 (e.g., processing units, cores, etc.) execute instructions stored in memory 544. Memory 544 can include high-speed random-access memory, such as DRAM, SRAM, DDR, RAM or other random-access solid-state memory devices, and may include non-volatile memory, such as one or more optical disk, magnetic disk, flash memory devices, or other non-volatile memory device(s). In some embodiments, memory 544 includes a non-transitory computer readable storage medium. In some embodiments, memory 544 or the computer readable storage medium of memory 544 stores programs, modules, and/or data structures, and/or instructions for controlling and/or training the humanoid robotic component and/or causing display of one or more images on an electronic display device and/or user interface device for user control.

Furthermore, the one or more processor(s) 542 can be a single processor or an architecture employing multiple processing units configured to process data and/or performing computation based on data. The one or more processor(s) 542 can include both hardware and software components. For example, the processor includes at least one hardware components such as an application-specific integrated circuit (ASIC), a programmable logic device (PLD), or a combination thereof. The PLD can be a complex programmable device (CPLD), a field-programmable gate array (FPGA), etc.

In some embodiments, the power module(s) 545 controls and/or manages the power requirements for one or more components of the wearable system 500A. For example, the power module(s) 545 provides a stable and efficient power source for the different electronic, robotic, sensory, control, and/or interface components of the wearable system 500A. In some embodiments, the power module is a computerized system that intelligently manages power balancing and/or consumption for the one or more components of the wearable system 500A.

FIG. 5B shows an example block diagram of a wearable system coupled with a humanoid robotic component, in accordance with some embodiments. In some embodiments, the wearable system 550 includes the same or similar components as those described above with respect to FIG. 5A. For example, the wearable system 550 includes the tactile sensor module 520, the position sensor module 530, the power module(s) 545, the processor(s) 542 and memory 544. In some embodiments, the wearable system 550 is configured to be worn by a humanoid robotic hand and is communicatively coupled to the control and/or processing circuitry of the humanoid robotic hand. For example, the control and/or processing circuitry of the humanoid robotic hand includes a robotic element 555, a robotic actuator 560, and robotic control and processing circuitry 565. In some embodiments, the control and/or processing circuitry of the humanoid robotic hand is similar to that described above with respect to FIGS. 1B, 2B, 3B and 4A-4C.

In some embodiments, the wearable system (e.g., 100A-400C of FIGS. 1A to 4C) interfaces with or has a vision device, such as a camera, for improving the user experience, enabling more seamless control and training of the robotic component. In some embodiments, the vision device is used for data and/or object labelling purposes to assist with the user training and/or control process. In some embodiments, the vision device could be smart glasses or extended-reality glasses. In some embodiments, the vision device is integrated into the wearable article.

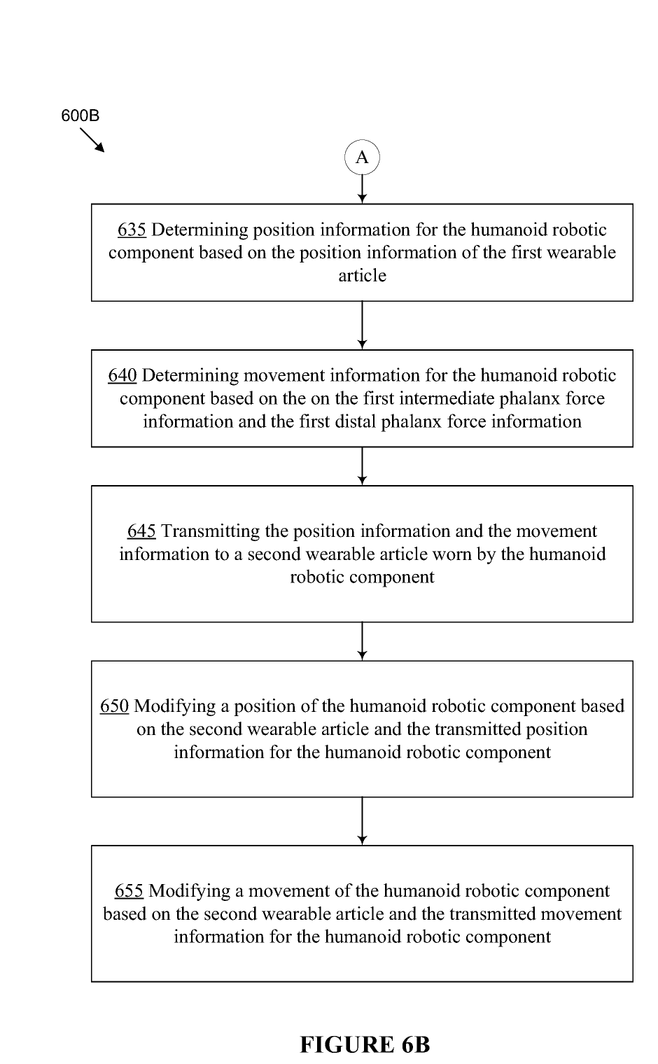

FIGS. 6A and 6B show an example embodiment of a process 600 for controlling a humanoid robotic system via a wearable system, in accordance with some embodiments. In some embodiments, the wearable system is as described above with respect to FIGS. 1A-5B.

(A1) In accordance with some embodiments, the process 600 receives 605, from a first wearable article worn by a user, training data for controlling a humanoid robotic component. The humanoid robotic component can include a part, or all, of the humanoid robotic system. The training data can be based on receiving 610, from a first set of position sensors of the first wearable article, position information of the first wearable article, receiving 615, from at least one tactile sensor of a first set of tactile sensors of the first wearable article, first intermediate phalanx force information associated with a first physical object, and receiving 625, from at least one tactile sensor of a second set of tactile sensors, first distal phalanx force information associated with the first physical object. In some embodiments, 620 the at least one tactile sensor of the first set of tactile sensors is positioned at an intermediate phalanx region of a respective finger portion of the first wearable article. In some embodiments, 630 the at least one tactile sensor of the second set of tactile sensors is positioned at a distal phalanx region of a respective finger portion of the first wearable article.

The method 600 includes determining 635, position information for the humanoid robotic component based on the position information of the first wearable article. At 640, the method 600 determines movement information for the humanoid robotic component based on the on the first intermediate phalanx force information and the first distal phalanx force information. The movement information and/or positional information can be based on joint angles, rotations, DOFs, and/or positional or movement trajectories. For example, the movement information includes calculating one or more joint torque adjustments and the position information is relative to an object being manipulated or an external frame of reference. At 645, the method 600 transmits the position information and the movement information to a second wearable article worn by the humanoid robotic component.

(A2) In some embodiments, the method 600 modifies (650) a position of the humanoid robotic component based on the second wearable article and the transmitted position information for the humanoid robotic component.

(A3) In some embodiments, the method 600 modifies (655) a movement of the humanoid robotic component based on the second wearable article and the transmitted movement information for the humanoid robotic component. The modification of the position and/or movement of the humanoid robotic component can be based on accumulated user interaction, training data, robotic feedback, and/or updates to the training algorithms (e.g., via machine learning, artificial intelligence, etc.).

In some embodiments, the training data is obtained while using the first wearable article (e.g., first glove) worn by the user to manipulate a first object and the training data is analyzed to determine and/or modify forces to be applied to a second object by the counterpart robotic component (e.g., robotic hand) fitted with the second wearable article (e.g., second glove). The training data can be stored for later use or applied in real-time. In some embodiments, the training data generation is stored for artificial intelligence training based on machine learning, generative artificial intelligence, neural networks, large language models, and/or artificial general intelligence. In some embodiments, the first glove and the second glove have the same sensor configuration. In some embodiments, the first glove and the second glove have the same sensor configuration and the same processing circuitry components. In some embodiments, a large number of robotic components fitted with respectively corresponding wearable articles are trained, manipulated, and/or controlled using one wearable article worn by a single user. In some embodiments, a large number of robotic components fitted with respectively corresponding wearable articles are trained, manipulated, and/or controlled using at least one wearable article worn by a user. In some embodiments, a large number of robotic components fitted with respectively corresponding wearable articles are trained, manipulated, and/or controlled using at least one wearable articles worn by one or more users.

Although embodiments describe the first wearable article worn by the user and the second wearable article worn by the robotic component, in some embodiments, the first wearable article is worn by a first robotic component and the second wearable article is worn by a second robotic component. This allows for a pre-trained and pre-programmed robotic component to train and/or update training algorithms for multiple other robotic components with wearable articles communicatively coupled with the first wearable article.

(A4) In some embodiments, the second wearable article has a second set of position sensors for tracking a position of the second wearable article; a third set of tactile sensors, wherein at least one tactile sensor of the third set of tactile sensors determines a third force applied to a second physical object and is positioned at an intermediate phalanx region of a respective finger portion of the second wearable article; and a fourth set of tactile sensors. At least one tactile sensor of the fourth set of tactile sensors determines a fourth force applied to the second physical object and is positioned at a distal phalanx region of a respective finger portion of the second wearable article.

(A5) In some embodiments, a first position sensor of the first set of position sensors is positioned at a palm region of the first wearable article and a second position sensor of the first set of position sensors is positioned at a proximal phalanx region of a finger portion of the first wearable article.

(A6) In some embodiments, the method 600 further includes a third position sensor and the second position sensor of the first set of position sensors positioned at different phalanx regions of the same finger portion of the first wearable article.

(A7) In some embodiments, the method 600 determines, based on an additional set of tactile sensors positioned at a palm region of the first wearable article, palm force information associated with the first physical object, and modifies, based on the palm force information associated with the first physical object, a force applied to a second physical object by the humanoid robotic component.

(A8) In some embodiments, the method 600 determines, a second intermediate phalanx force for a second physical object based on the intermediate phalanx force information received from the at least one tactile sensor of the first set of tactile sensors of the first wearable article; determines a second distal phalanx force for the second physical object based on the distal phalanx force information received from the at least one tactile sensor of the second set of tactile sensors; and modifies, based on the second intermediate phalanx force and the second distal phalanx force, a force applied to the second physical object by the humanoid robotic component.

(A9) In some embodiments, the second wearable article and the first wearable article are communicatively coupled to one another. For example, the wearable articles described above with respect to FIGS. 1A-4C have processing and network circuitry to enable direct communications, in-sync data acquisition, control, and live training.

(B1) In accordance with some embodiments, a non-transitory computer-readable storage medium storing instructions, which, when executed by a system that includes an apparatus and one or more processors, causes the one or more processors to perform a set of operations, including any of (A1)-(A9).

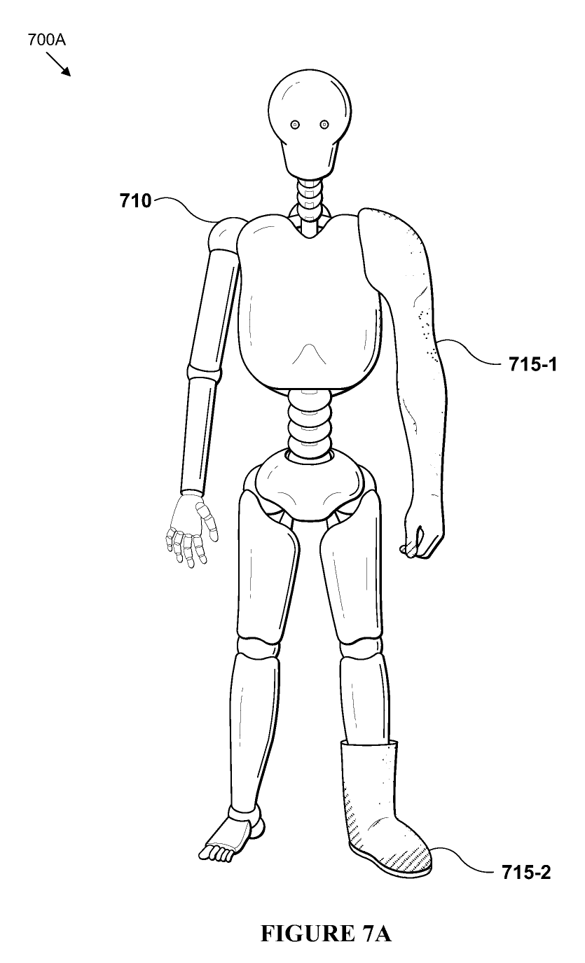

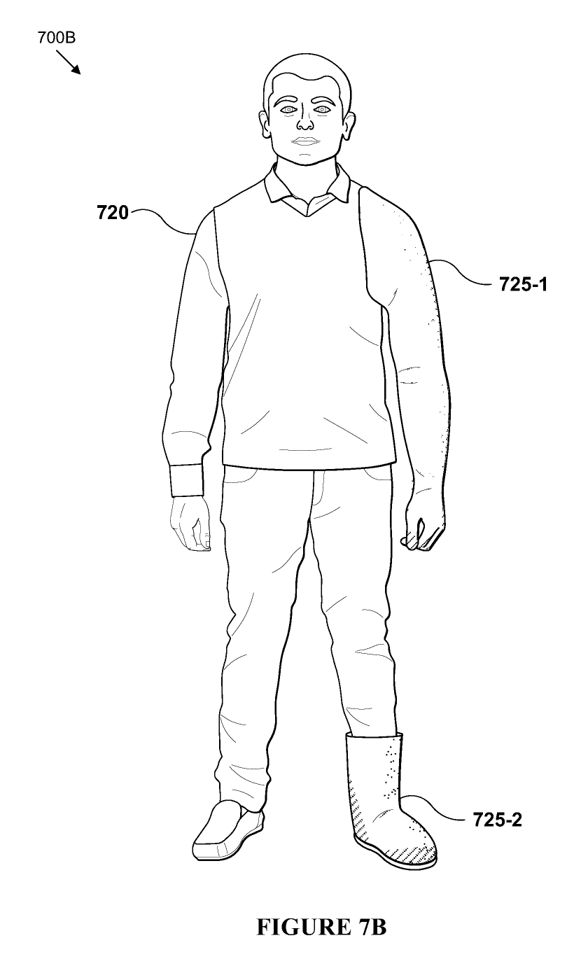

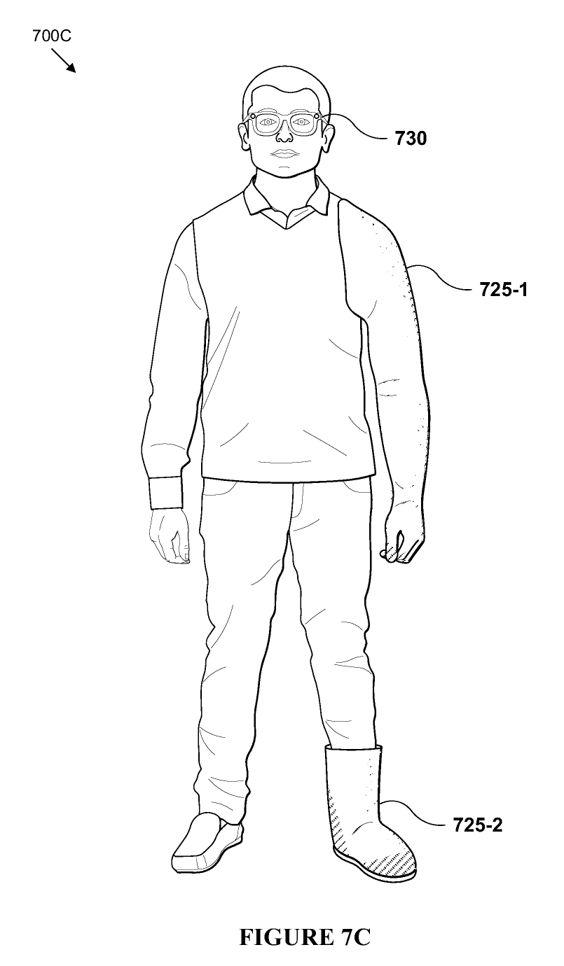

FIGS. 7A and 7B illustrate a humanoid robot and a user having a plurality of wearable articles of a wearable system, in accordance with some embodiments. In some embodiments, the plurality of wearable articles is similar to the one or more wearable articles described above with respect to FIGS. 1A-4C in communication with another. FIG. 7A shows a humanoid robot 710 having a first wearable article 715-1 of a first group of wearable articles and a second wearable article 715-2 of the first group of wearable articles.

In some embodiments, the first wearable article 715-1 of the first group of wearable articles is positioned on an arm and shoulder of the humanoid robot 710. In some embodiments, the second wearable article 715-2 of the first group of wearable articles is positioned on a foot of the humanoid robot. The first wearable article 715-1 and the second wearable article 715-2 of the first group of wearable articles can be in communication with each other via in-built network circuitry and/or external network circuitry. The first wearable article 715-1 and the second wearable article 715-2 of the first group of wearable articles can be determined to be shaped and/or control any one or more regions or portions of the humanoid robot.

FIG. 7B shows a user 720 having a first wearable article 725-1 of a second group of wearable articles and a second wearable article 725-2 of the second group of wearable articles. In some embodiments, the first wearable article 725-1 of the second group of wearable articles is positioned on an arm and shoulder of the user 720. In some embodiments, the second wearable article 725-2 of the second group of wearable articles is positioned on a foot of the user 720. In some embodiments, the first group of wearable articles and the second group of wearable articles are in communication with each other and/or part of a same wearable system 700.

The wearable system 700 acquires real-time, synchronized data from a plurality of sensors associated with the first group of wearable articles and/or the second group of wearable articles to continually, sequentially, and/or periodically update control, training, and/or manipulation algorithms corresponding to the respective regions of the humanoid robotic that have at least the first wearable article 715-1 of the first group of wearable articles and the second wearable article 715-2 of the first group of wearable articles.

Additionally, or alternatively, the user 720 can be a trained humanoid robot having the first wearable article 725-1 and the second wearable article 725-2 of the second group of wearable articles to train one or more additional robots.

FIG. 7C shows a perspective view of a user wearing smart glasses and having a plurality of wearable articles, in accordance with some embodiments. In some embodiments, the wearable systems described above in FIGS. 1A-4C, 7A, and 7B are in communication with smart glasses 730 and/or additional vision, motion detection, and/or positional devices. The wearable system 700 can provide an improved and seamless user experience that aids in collecting data from the second group of wearable articles. For example, the smart glasses 730 can be extended-reality glasses that provide the user with a virtual visual training program and/or real-time feedback (e.g., as part of a display of the smart glasses) of the counterpart humanoid robot’s movements, control, training, and/or position. In some embodiments, the wearable system 700 can aid with data labelling and enable the user 720 to identify one or more physical objects, as associated with corresponding training algorithms, and provide large scale, real-time accumulation of training data.

Systems, methods, and devices described herein enable reduction and/or elimination of translation errors (e.g., from vision systems to robotic control systems) in the training and/or manipulation of humanoid robotic components by providing a one-to-one and/or direct correspondence using the plurality of wearable articles.

Embodiments of the present disclosure can relate to an apparatus for performing the operations herein. This apparatus can be specifically constructed for the specific purposes, and/or it can include a general-purpose computing device selectively activated or reconfigured by a computer program stored in the processor module. Such a computer program can be stored in a non-transitory computer-readable storable medium, or any type of media suitable for storing electronic instructions, which can be coupled to a computer system bus.

Embodiments of the present disclosure can also relate to a product that is produced by a computing process described herein. In some embodiments, such a product includes information resulting from a computing process, where the information is stored on a non-transitory, computer readable storage medium. The information can include any embodiments of a computer program product or other data combination described herein.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen to explain the principles underlying the claims and their practical applications, to thereby enable others skilled in the art to best use the embodiments with various modifications as are suited to the particular uses contemplated. For example, each of the elements of the aforementioned embodiments may be utilized alone or in combination or sub-combination with elements of the other embodiments. The present disclosure may be embodied in other equivalent forms without departing from the scope of the present disclosure.

1. A wearable system for controlling a humanoid robotic component, comprising:
a first wearable article, wherein the first wearable article comprises:
a first set of position sensors for tracking a position of the first wearable article;
a first set of tactile sensors, wherein at least one tactile sensor of the first set of tactile sensors determines a first force applied to a first physical object and is positioned at an intermediate phalanx region of a respective finger portion of the first wearable article; and
a second set of tactile sensors, wherein:
at least one tactile sensor of the second set of tactile sensors determines a second force applied to the first physical object, and
the at least one tactile sensor of the second set of tactile sensors is positioned at a distal phalanx region of the respective finger portion of the first wearable article.

2. The wearable system of claim 1, wherein the first wearable article is configured to be worn by a user.

3. The wearable system of claim 2, further comprising:
a second wearable article configured to be worn by the humanoid robotic component, wherein the second wearable article comprises:
a second set of position sensors for tracking a position of the second wearable article;
a third set of tactile sensors, wherein at least one tactile sensor of the third set of tactile sensors determines a third force applied to a second physical object and is positioned at an intermediate phalanx region of a respective finger portion of the second wearable article; and
a fourth set of tactile sensors, wherein:
at least one tactile sensor of the fourth set of tactile sensors determines a fourth force applied to the second physical object, and
the at least one tactile sensor of the fourth set of tactile sensors is positioned at a distal phalanx region of a respective finger portion of the second wearable article.

4. The wearable system of claim 3, wherein the first set of position sensors, the first set of tactile sensors, and the second set of tactile sensors generate training data when the first wearable article is worn by the user and the second wearable article is configured to train a movement of the humanoid robotic component based on the training data.

5. The wearable system of claim 3, wherein the second wearable article includes a plurality of positioning datums for positioning the second wearable article on the humanoid robotic component.

6. The wearable system of claim 2, further comprising:
an additional set of tactile sensors for determining a third force applied to the first physical object, wherein each tactile sensor of the additional set of tactile sensors is positioned at a palm region of the first wearable article.

7. The wearable system of claim 2, wherein a first position sensor of the first set of position sensors is positioned at a palm region of the first wearable article.

8. The wearable system of claim 7, wherein a second position sensor of the first set of position sensors is positioned at a proximal phalanx region of a finger portion of the first wearable article.

9. The wearable system of claim 8, wherein a third position sensor and the second position sensor of the first set of position sensors are positioned at different phalanx regions of a same finger portion of the first wearable article.

10. The wearable system of claim 1, wherein the second wearable article and first wearable article are communicatively coupled to one another and the first force and the second force applied to the first physical object are the same.

11. A method for controlling a humanoid robotic system, comprising:
receiving, from a first wearable article worn by a user, training data for controlling a humanoid robotic component, wherein the training data is based on:
receiving, from a first set of position sensors of the first wearable article, position information of the first wearable article;
receiving, from at least one tactile sensor of a first set of tactile sensors of the first wearable article, first intermediate phalanx force information associated with a first physical object, wherein the at least one tactile sensor of the first set of tactile sensors is positioned at an intermediate phalanx region of a respective finger portion of the first wearable article; and
receiving, from at least one tactile sensor of a second set of tactile sensors, first distal phalanx force information associated with the first physical object, wherein the at least one tactile sensor of the second set of tactile sensors is positioned at a distal phalanx region of a respective finger portion of the first wearable article;
determining position information for the humanoid robotic component based on the position information of the first wearable article;
determining movement information for the humanoid robotic component based on the on the first intermediate phalanx force information and the first distal phalanx force information; and
transmitting the position information and the movement information to a second wearable article worn by the humanoid robotic component.

12. The method for controlling the humanoid robotic system of claim 11, further comprising:
modifying a position of the humanoid robotic component based on the second wearable article and the transmitted position information for the humanoid robotic component; and
modifying a movement of the humanoid robotic component based on the second wearable article and the transmitted movement information for the humanoid robotic component.

13. The method for controlling the humanoid robotic system of claim 11, wherein the second wearable article comprises:
a second set of position sensors for tracking a position of the second wearable article;
a third set of tactile sensors, wherein at least one tactile sensor of the third set of tactile sensors determines a third force applied to a second physical object and is positioned at an intermediate phalanx region of a respective finger portion of the second wearable article; and
a fourth set of tactile sensors, wherein:
at least one tactile sensor of the fourth set of tactile sensors determines a fourth force applied to the second physical object, and
the at least one tactile sensor of the fourth set of tactile sensors is positioned at a distal phalanx region of a respective finger portion of the second wearable article.

14. The method for controlling the humanoid robotic system of claim 13, wherein a first position sensor of the first set of position sensors is positioned at a palm region of the first wearable article and a second position sensor of the first set of position sensors is positioned at a proximal phalanx region of a finger portion of the first wearable article.

15. The method for controlling the humanoid robotic system of claim 14, wherein a third position sensor and the second position sensor of the first set of position sensors are positioned at different phalanx regions of the same finger portion of the first wearable article.

16. The method for controlling the humanoid robotic system of claim 11, further comprising:
determining, based on an additional set of tactile sensors positioned at a palm region of the first wearable article, palm force information associated with the first physical object; and
modifying, based on the palm force information associated with the first physical object, a force applied to a second physical object by the humanoid robotic component.

17. The method for controlling the humanoid robotic system of claim 11, further comprising:
determining a second intermediate phalanx force for a second physical object based on the intermediate phalanx force information received from the at least one tactile sensor of the first set of tactile sensors of the first wearable article;
determining a second distal phalanx force for the second physical object based on the distal phalanx force information received from the at least one tactile sensor of the second set of tactile sensors; and
modifying, based on the second intermediate phalanx force and the second distal phalanx force, a force applied to the second physical object by the humanoid robotic component.

18. A non-transitory computer-readable storage medium storing instructions, which, when executed by a system that includes an apparatus and one or more processors, causes the one or more processors to perform a set of operations, including:
receiving, from a first wearable article worn by a user, training data for controlling a humanoid robotic component, wherein the training data is based on:
receiving, from a first set of position sensors of the first wearable article, position information of the first wearable article;
receiving, from at least one tactile sensor of a first set of tactile sensors of the first wearable article, first intermediate phalanx force information associated with a first physical object, wherein the at least one tactile sensor of the first set of tactile sensors is positioned at an intermediate phalanx region of a respective finger portion of the first wearable article; and
receiving, from at least one tactile sensor of a second set of tactile sensors of the first wearable article, first distal phalanx force information associated with the first physical object, wherein the at least one tactile sensor of the second set of tactile sensors is positioned at a distal phalanx region of a respective finger portion of the first wearable article;
determining position information for the humanoid robotic component based on the position information of the first wearable article;
determining movement information for the humanoid robotic component based on the on the first intermediate phalanx force information and the first distal phalanx force information; and
transmitting the position information and the movement information to a second wearable article worn by the humanoid robotic component.

19. The non-transitory computer-readable storage medium of claim 18, further storing instructions for:
modifying a position of the humanoid robotic component based on the second wearable article and the transmitted position information for the humanoid robotic component; and
modifying a movement of the humanoid robotic component based on the second wearable article and the transmitted movement information for the humanoid robotic component.

20. The non-transitory computer-readable storage medium of claim 18, wherein the second wearable article comprises:
a second set of position sensors for tracking a position of the second wearable article;
a third set of tactile sensors, wherein at least one tactile sensor of the third set of tactile sensors determines a third force applied to a second physical object and is positioned at an intermediate phalanx region of a respective finger portion of the second wearable article; and
a fourth set of tactile sensors, wherein:
at least one tactile sensor of the fourth set of tactile sensors determines a fourth force applied to the second physical object, and
the at least one tactile sensor of the fourth set of tactile sensors is positioned at a distal phalanx region of a respective finger portion of the second wearable article.
